(19) United States
(12) Patent Application Publication
(10) Pub. No.: US 2024/0411298 A1
(43) Pub. Date: Dec. 12, 2024

(54) DETECTION OF BEHAVIOR ANOMALIES IN CONTROL SYSTEMS AND RELATED SYSTEMS, METHODS, AND DEVICES

(71) Applicants: Battelle Energy Alliance, LLC, Idaho Falls, ID (US); George Mason University Dr., Fairfax, VA (US); University of Idaho, Moscow, ID (US)

(72) Inventors: Craig G. Rieger, Pocatello, ID (US); Robert Christopher Ivans, Ammon, ID (US); Konstantinos Kolias, Idaho Falls, ID (US); Daniel Barbara, Reston, VA (US)

(21) Appl. No.: 18/697,707

(22) PCT Filed: Oct. 14, 2022
(86) PCT No.: PCT/US2022/078107

§ 371 Date: Apr. 1, 2024

Related U.S. Application Data
(60) Provisional application No. 63/262,600, filed on Oct. 15, 2021.

(51) Int. Cl. G05B 23/02

(52) U.S. Cl. CPC G05B 23/0221

(57) ABSTRACT

Detection of behavior anomalies in control systems and related systems. methods. and devices is disclosed. A method of detecting behavior anomalies in a control system includes probing emanations from a processor controlling at least a portion of the control system to provide an emanations signal. amplifying the emanations signal to provide an amplified emanations signal. and sampling the amplified emanations signal using a sampling rate that is greater than a clock frequency of a processor clock of the processor to provide samples. The method also includes determining whether or not the processor is exhibiting a behavior anomaly responsive to the samples.

### CROSS-REFERENCE TO RELATED APPLICATIONS

This application is a national phase entry under 35 U.S.C. § 371 of International Patent Application PCT/US2022/078107, filed Oct. 14, 2022, designating the United States of America and published in English as International Patent Publication WO 2023/064894 A1 on Apr. 20, 2023, which claims the benefit under Article 8 of the Patent Cooperation Treaty to U.S. Application Ser. No. 63/262,600, filed Oct. 15, 2021, the contents of both of which are hereby incorporated by reference in their entireties.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to detection of behavior anomalies in control systems, and more specifically to detection of behavior anomalies in noisy industrial control systems (ICSs).

### BACKGROUND

Critical infrastructure are examples of control systems that society relies on for maintaining health and stability. These systems have been designed to cope with events like natural disasters and maintenance outages, but their ever-growing reliance on network connectivity introduces concerns from evolving cyber threats. Cyber-attacks have been used to successfully disable, damage, and disrupt the function of control systems.

### BRIEF SUMMARY

In some embodiments a monitoring system to monitor a control system includes an electromagnetic (EM) probe, an amplifier, and control circuitry. The EM probe is configured to generate an emanations signal responsive to EM emanations from a processor configured to control at least a portion of the control system. The amplifier is configured to generate an amplified emanations signal responsive to the emanations signal. The control circuitry is configured to determine whether the processor is exhibiting a behavior anomaly responsive to samples taken of the amplified emanations. The samples are taken at a rate that is faster than a processor clock frequency of the processor.

In some embodiments a method of detecting behavior anomalies in a control system includes probing electromagnetic emanations from a processor controlling at least a portion of the control system to provide an emanations signal. The method also includes amplifying the emanations signal to provide an amplified emanations signal and sampling the amplified emanations signal using a sampling rate that is greater than a clock frequency of a processor clock of the processor to provide samples. The method further includes determining whether or not the processor is exhibiting a behavior anomaly responsive to the samples.

In some embodiments a system includes an industrial control system and a monitoring system. The industrial control system includes a processor configured to control at least a portion of the industrial control system. The monitoring system includes an electromagnetic (EM) probe, a sampling circuitry, and control circuitry. The EM probe is configured to generate an emanations signal responsive to EM emanations from the processor. The sampling circuitry is configured to generate samples responsive to the emanations signal. The control circuitry is configured to determine whether the processor is exhibiting a behavior anomaly responsive to the samples.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 illustrates accuracy plots for various levels of pollution rates (PRs) and signal-to-noise-ratios, according to some embodiments;

FIG. 2 illustrates accuracy plots for various levels of sampling rates and signal-to-noise-ratios, according to some embodiments;

FIG. 3 includes accuracy plots illustrating accuracy achieved for various pollution rates, SNRs, and sampling rates (SRs), according to some embodiments;

FIG. 4 is a block diagram of a system, according to some embodiments;

FIG. 5 illustrates plots of examples of benign and malicious amplified emanations signals (e.g., the amplified emanations signal of FIG. 4), according to some embodiments;

FIG. 6 is an average 3-NN distance plot illustrating an average distance of three closest neighbors (average 3-NN distance) of each individual signal (normal or anomalous) in the dataset to the totality of normal signals that is considered as the baseline, according to some embodiments;

FIG. 7 illustrates examples of AUC score plots for average (among all folds) AUC scores achieved across different SNR levels, according to some embodiments;

FIG. 8 illustrates example average accuracy plots (among all folds) showing ACC scores achieved after the application of noise elimination filters, for the NOP injection case;

FIG. 9 is a plot illustrating similarity of individual signals to the baseline on the clean dataset, a noisy version at −10 dB, and a version after applying an SVD noise filter, according to some embodiments;

FIG. 10 includes TP rate plots illustrating improvement on the AUC best fold on noisy environments (−10 dB) and the worst fold after the application of SVD filter, according to some embodiments;

FIG. 11 is a flowchart illustrating a method of detecting behavior anomalies in a control system (e.g., a control system of FIG. 4), according to some embodiments; and

FIG. 12 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

The difficulty in applying traditional security mechanisms in ICS environments makes a large portion of these mission-critical assets vulnerable to cyber-attacks. Therefore, novel security mechanisms specifically designed to protect such critical systems are being developed. Device EM emanations may be used for defense purposes, and especially for the detection of possible anomalous behavior. Such approaches may lead to the development of robust external and non-intrusive anomaly detection mechanisms. Nevertheless, many such approaches may neglect to consider the implications of real-life environments, particularly environmental noise. Since ICS devices often reside and operate in noisy environments. This noise may lead to unpredictable results where EM methods are used to detect behavior anomalies.

Conventional IT security devices such as firewalls and intrusion detection systems (IDSs) have proven to be insufficient against advanced threats. Attacks are becoming increasingly automated to the point where human response may not mitigate a cyber threat. An operational technology (OT) system (e.g., an ICS, without limitation) may potentially even have only a single vulnerability exploited by an attack to cause severe damage. New techniques such as side channel indicators may help to recognize attacks at a high fidelity for combating modern cyber threat.

In various embodiments disclosed herein, the limits of EM-based anomaly detection may be discussed to identify injection attacks in control logic software in noisy environments. Environmental noise may significantly degrade the anomaly detection process. Nevertheless, assuming that signals are captured with high sampling rates, even minor injections may be detected with above −90% accuracy in noisy environments where SNR is up to −2 dB. Moreover, experiments in a real-life testbed attest that even single-instruction injections may be detected with near perfect accuracy in relatively clean environments. Such attacks may still be detected reliably even in noisy environments after the application of noise-elimination techniques.

Devices that are the building blocks of ICS networks include programmable logic controllers (PLCs), intelligent electronic devices (IEDs) and remote terminal units (RTUs) and industrial internet of things (IIoT) smart-sensors. Such devices may generally be designed to execute a single task that is directly related to a physical process. Also, these devices tend to be limited in terms of resources (e.g., computing power, data storage capacity, communication bandwidth, without limitation), which in turn leaves little-to-no room for supplementary security features.

One approach for implementing security mechanisms in ICS environments is to define a multi-tiered, dynamic framework for cyber resilience in control systems. For example, implementing external monitoring and protection mechanisms for maintaining a high level of proactive state of awareness is helpful. Mature security mechanisms such as anti-malware tools and host-based intrusion detection systems (IDSs), however, may not be natively implemented in these resource-limited devices, and cryptographically secure communication protocols may not be supported.

In various embodiments, defense systems may be based, at least in part, upon an analysis of side channels that get emitted involuntarily by device components. Compared to the traditional network (N-IDS), such approaches may detect compromises and the execution of malicious code, even if the malware never produces any network footprint or it remains in an installed-but-dormant state. Alternative side-channels including power consumption patterns, thermal footprint, or the acoustic signals of devices during their operation may be monitored to detect cyber-attacks and/or threats. Nevertheless, electromagnetic (EM) based approaches offer a comparative advantage since the signals themselves may be captured and analyzed in a non-intrusive (e.g., completely non-intrusive) fashion (e.g., no installation of software in the monitored device is assumed). In contrast to power consumption signals, the EM spectrum offers high bandwidth. In the same vein, unlike the analysis of thermal output (e.g., via infrared cameras), equipment to capture EM signals may do so in high sampling rates. Both of these factors (high bandwidth EM spectrum and high sampling rates) contribute to a fast and fine-grained analysis.

Despite its advantages, EM-based analysis has been proven extremely sensitive to the placement of the monitoring equipment and external environmental conditions. Unfortunately, conventional systems have failed to consider the implications of real-life conditions that exist in industrial settings and, more specifically, the impact of EM noise that is omnipresent in such environments. In theory, noise may severally degrade the predictive accuracy of existing EM-based anomaly detection techniques.

Various embodiments disclosed herein provide an ample evaluation of EM-based anomaly detection defenses in the presence of EM noise. Minute modifications in the control logic that are likely to go unnoticed are disclosed herein. The limits of EM-based anomaly detection are identified, and the impact of several factors influencing the efficiency of the corresponding defense mechanisms are quantified herein.

Experimental evaluation on synthetic data indicates that it is possible to detect minimal code-injection attacks, even ones having a pollution rate of just 1%, with above 90% accuracy. This may be achieved despite the impact of strong environmental noise, even reaching SNR levels of −8 dB. In such cases, one factor influencing the anomaly detection process is the sampling rate. Experimental results indicate that to achieve granular detection of such minute anomalies, the sampling rate should be at least eight times the speed of the CPU clock. Adopting sampling rates near the limits dictated by the Nyquist rate often results in poor performance, as the samples describing the anomalies are negligible in comparison to all other samples. More importantly, experiments conducted in a real deployment show that even single-instruction injections may be detected with above 90% accuracy on relatively noise-free environments if the sampling rate is high. The singular value decomposition (SVD)-based method for noise reduction provides near-perfect accuracy for the detection of attacks, even in extremely noisy environments (e.g., −10 dB SNR). The ability to accurately recognize cyber-attacks in spite of noise allows not only to maintain full awareness (recon) but also for surgical (e.g., precise) mitigation (resist and respond).

Industrial devices such as smart-sensors and PLCs, which typically interact directly with physical processes, have significant differences from mainstream high-end computers. For example, these industrial devices have much lower hardware capabilities, including a CPU speed of just a few megahertz (Mhz), and a limited amount of memory. These industrial devices also tend to rely on real-time operating systems (RTOS) or execute instructions directly at the hardware level (“bare metal”). Typically, these industrial devices operate continuously under harsh environmental conditions, including high levels of noise and interference. Moreover, these industrial devices may be replaced after many years of continuous operation with only occasional update cycles throughout their lifetimes. Finally, such industrial devices may generally be designed to perform simple and well-defined tasks, but with extremely high levels of reliability, according to principles of embedded systems design.

The software that runs in such systems is responsible for the governing and/or inspection of a physical process. This software may also be referred to as “control logic.” This type of software may run perpetually, in a loop. Although control logic may become complex, it typically has a much simpler structure in comparison to software seen in high-end IT systems.

The mechanisms responsible for the updating of the control logic may be plagued by weaknesses. These weaknesses may revolve around naïve, passwords-based authentication, as well as poor design decisions regarding the use of cryptographic primitives. Alternatively, attackers may exploit existing bugs in the control logic itself. The latter is also known as control logic hijacking or a control logic injection attack. For example, buffer overflow methodologies may be applied in embedded systems. Regardless, the outcome of both methodologies is the alteration in the sequence of the set of machine-level instructions of a specific execution path Ci with the intention of affecting the physical process itself. The end result may vary from harming equipment to a large-scale environmental damage, which in turn may endanger human lives.

EM-based anomaly detection capitalizes on the relationship between instructions executed at the machine level and the EM signals emitted involuntarily as the natural outcome of this process. Every time a new instruction is executed, slightly different amounts of current are drawn by the CPU. This results in the formation of EM fields, and therefore, the emanation of EM signals. Theoretically, these signals may act as indicators of the type of instructions executed by the CPU at any given time. A correlation may exist between the CPU activity, the current drawn, and the creation of EM signals. Specifically, the CPU may act as a transmitter that performs amplitude modulation over a carrier (i.e., the CPU clock).

Control logic injections in the discrete time-domain representation of the EM signal may be discussed as follows: Assume a signal Sim of length m, which is normally obtained by the execution of instructions in an execution path Ci. Assume a signal AnM of length n, which is obtained by the execution of an arbitrary sequence of malicious instructions M. It is assumed that n<<m, because extensive alterations in control logic tend to raise immediate suspicions. Then, the signal corresponding to a control logic injection is a version of that signal that is obtained as in Equation 1:

$${S}_{m + n}^{ℳ} = S [ 1 … k ] , {Δ}^{ℳ} [ 1 … n ] , S [ k + 1 … m + n ] \qquad ( 1 )$$

where k is the point of injection. FIG. 5 (discussed below) illustrates the impact of an injection attack from the EM perspective.

The anomaly detection task falls down to discerning whether an unknown signal Sq corresponds to a known, normal execution path Ci or a polluted one CiM. Several factors have been identified to play a detrimental or amplifying role in the anomaly detection process including the extent of the modification denoted here as pollution rate, the levels of noise here described as signal-to-noise-ratio, and the sampling rate at which the signal is obtained.

As used herein, the term “pollution rate” (PR) is a metric of the extent of the corruption inflicted to the original executional path. PR may be calculated using Equation 2.

$$PR = \frac{\vert ℳ \vert}{\vert {𝒞}_{i}^{ℳ} \vert} \qquad ( 2 )$$

More specifically, PR is the ratio of maliciously injected (at the machine level) instructions |M| to the total number of instructions that constitute the studied executional path, which is:

$$\vert {𝒞}_{i}^{ℳ} \vert = \vert ℳ \vert + \vert {𝒞}_{i} \vert \qquad ( 3 )$$

where |Cᵢ| is the number of instructions comprising the original path. Theoretically, the smaller the PR, the harder it is to identify an anomaly by simply observing the EM spectrum from a time domain perspective.

As used herein, the term signal-to-noise-ratio (SNR) is a measure of the quality of the signal relative to noise on the signal. SNR may be calculated as in Equation 4.

$$SNR = 10 {log}_{10} \frac{{P}_{s}}{{P}_{n}} \qquad ( 4 )$$

where Pₛ is the power of the signal and Pₙ is the power of noise. SNR may be measured in dB. Theoretically, the lower the SNR, the harder it becomes to identify whether a series has been subjected to alterations.

As used herein, the term “sampling rate” (SR) refers to the number of elements in a discrete-time sequence, per unit time, describing an analog signal. According to the Nyquist theorem, the minimum SR should be at least two times greater than the frequency of the signal in order for the resulting sequence to be unaffected by the negative impacts of the aliasing phenomenon. Theoretically, with higher sampling rates, a given anomaly in a time series may be described by more data points.

A rudimentary anomaly detection method that is based on the k-nearest neighbors (k-NN) algorithm may be relied on for evaluating purposes. One example of k-NN is a supervised machine learning (ML) algorithm. This implies that instances (EM signals) of normal and anomalous states are given a priori. However, in this context, it is not valid to assume knowledge of all anomalous cases. For example, assuming that an attacker has identified a vulnerability in code, the attacker may inject a single instruction to alter the value of a potentially critical variable. In fact, any of the numerous logical combinations of instructions that the CPU architecture supports may potentially be injected. The alternative ways to create anomalies are potentially infinite. Therefore, providing labels for anomalous cases is impractical. Toward this end, a semi-supervised version of k-NN where knowledge of only the normal case is assumed may be relied on. This is a realistic assumption as such signals may be captured at an early stage, even before the deployment of the system. Another reason for this choice of algorithm is the fact that k-NN performs lazy learning (e.g., no model is created during system training), but rather the modeling process is delayed until the deployment phase. The generalization ability of a specific algorithm across different noise environments may not be analyzed, but rather the effects of noise in distinguishing between normal and anomalous signals may be quantified.

In training a system, the algorithm is fed with a set of normal signals X (e.g., only normal signals without signals affected by abnormalities). Then, an exhaustive process of comparing each signal xi with the rest in this set takes place to infer a distance score Di of xi. More specifically, the distance score Di is calculated by formula 5:

$${D}_{i} ( X , {x}_{i} ) = \frac{\sum {min}_{k} \{ d ( {x}_{j} , {x}_{i} \} ∀ {x}_{j} \neq {x}_{i} ∈ X )}{k} \qquad ( 5 )$$

where d is a distance metric such as Euclidean distance, and minₖ are the k closest neighbors to xᵢ. Finally, the values {D^{min}, D^{max}} are treated as the thresholds of normalcy. These thresholds are inferred from the data, and they may not be manually decided but rather specific to each dataset. The absolute minimum and maximum values may constitute too strict criteria for establishing thresholds, especially for non-trivial scenarios in real-life situations. By adopting this method, a baseline for comparison is simply provided rather than achieving the optimal accuracy. Alternative methods like STROUD may prove more valuable for such purposes as these alternative methods may define thresholds based on more robust statistical criteria. An example of the sequence of these operations is described in Algorithm 1.

Algorithm 1 k-NN-based Threshold Inference Phase

| | |
|---|---|
| 1: | function INFERTHRESHOLDS:(benign dataset X) |
| 2: | for ∀xᵢ ∈ X do |
| 3: | D ← Dᵢ(X, xᵢ) |
| 4: | end for |
| 5: | D^{min} ← min(D) |
| 6: | D^{max} ← max(D) |
| | return D^{min}, D^{max} |
| 7: | end function |

During deployment of a system, a new signal xq is acquired whose label is unknown (normal, anomalous). Once again, an exhaustive process of comparing that signal with the rest in set X takes place to calculate the score Dq. Finally, if Dmin≤Dq≤Dmax then the signal is flagged as normal, or anomalous otherwise. These operations are outlined in Algorithm 2.

Increasing the efficiency of anomaly detection may not necessarily be the objective of embodiments disclosed herein. The disclosed anomaly detection method is chosen as the basis to conduct a comparative study regarding the limits of EM-based anomaly detection under the influence of various factors.

Algorithm 2 k-NN-based Anomaly Detection Phase

| | |
|---|---|
| 1: | function DETECTION:(benign dataset X, thresholds |
| | D^{min}, D^{max}, test |
| | signals x_{q}) |
| 2: | status_{q} ← normal |
| 3: | score_{q} ← D_{q}(X, x_{q}) |
| 4: | if score_{q} ≤ Dₘᵢₙ or score_{q} ≥ Dₘₐₓ then |
| 5: | status_{q} ← anomalous |
| 6: | end if |
| | return status_{q} |
| 7: | end function |

Synthetic Datasets: For the sake of simplicity, the period T of normal signals may optionally be set to one second (unrealistically long), and the corresponding frequency F of the CPU may be set to 1000 (unrealistically slow). Each instruction may range between amplitudes 3 mV to 6 mV. Since there is a finite number of supported instructions by CPU architectures (for example, a list of AVR CPU architecture instructions), and since each instruction (or sequence of instructions) modulates the signal in a different way, the resulting amplitude levels are also finite. The base dataset may include 1000 examples of the same basic signal with random (but minor) fluctuations of the amplitude ranging from −0.2 mV to 0.2 mV per example.

Several variations of this basic dataset were produced by altering specific characteristics, namely, the SR, PR, and SNR. Different SR levels were considered, starting from ×2 and increasing up to ×32 times the base frequency of the signal with an increment operation of 2 (for example, ×2, ×4, . . . , ×32). The anomalous signals may be created by injecting an invalid, never-seen-before sequence exactly in the middle of all benign signals. Different PR were considered, ranging from 1% to 20%, with an increment operation of 2.5% (for example, 1%, 2.5%, . . . , 20%). Variations were considered after applying different levels of additive white Gaussian noise (AWGN) (i.e., the type of noise that mostly affects ICS settings). Finally, various noise levels were taken into account, ranging from −10 dB (i.e., the noise is 10 times stronger than the signal) to 10 dB (i.e., the signal is 10 times stronger than the noise) with an increment operation of 2 dB (for example, −10 dB, −8 dB, . . . , 10 dB).

An evaluation method is proposed in which, for this set of experiments, the efficiency was measured based on the accuracy (ACC). ACC is defined as:

$$ACC = \frac{TP + TN}{TP + TN + FP + FN} \qquad ( 6 )$$

where TP is the total number of true positives, TN the number of true negatives, FP the number of false positives, and FN as the number of false negatives.

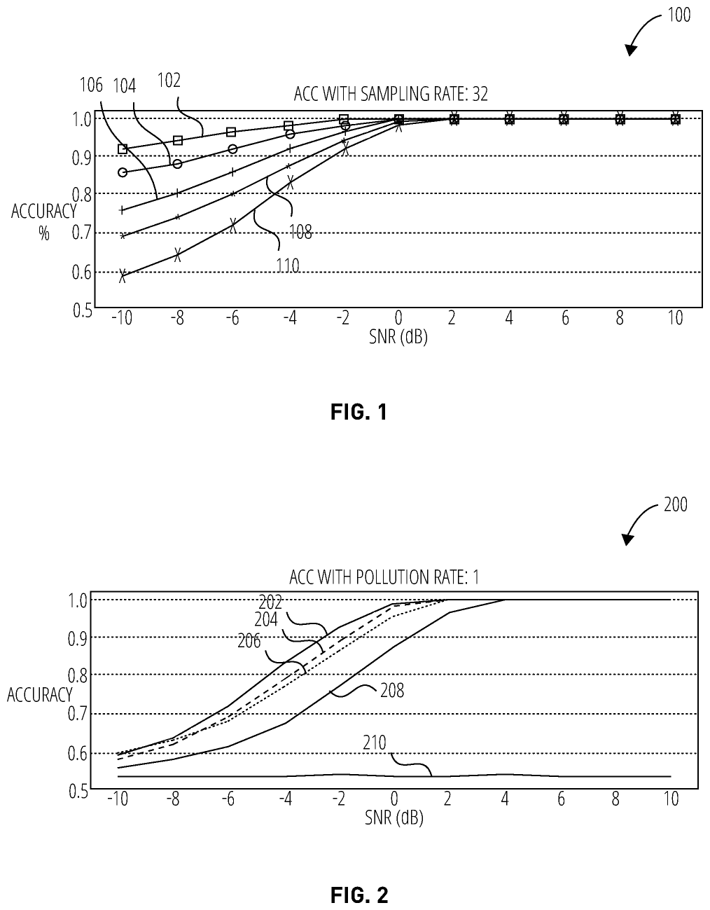

A metric such as ACC should not be considered in applications where the classes of signals (normal, anomalous) are heavily imbalanced. For example, in a protected network, successful PLC compromises are expected to be rare incidents in the benign (in its majority) operational lifespan of each device. However, for this set of experiments, ACC may be considered because (a) the considered test sets are balanced, and (b) for reasons of direct comparison with relevant bibliography. Subsequent experiments based on real-life setup (such as experiments discussed with reference to FIG. 1 through FIG. 3) additionally report F1 and area under the curve (AUC) scores.

In the experiments discussed herein, the ten-fold cross-validation strategy is used for evaluation purposes. For every fold, the number of signals used for training purposes was 90% of the entire normal dataset. The testing set was 10% of the normal dataset, and an equal number of anomalous signals was added. For all metrics, the average across all folds, along with the worst-case scenario, was calculated and reported.

A total of 1000 thresholds were considered, ranging from the minimum distance (0) to the maximum distance observed. The ACC reported for each fold is the maximum among all thresholds considered. The ACC of the neighborhood is the mean ACC for all folds. Neighborhoods of 3, 5, 10, 25, 50, 75, and 100 neighbors were considered. The overall accuracy reported is the best among all the neighborhoods.

FIG. 1 illustrates accuracy plots 100 for various levels of pollution rates (PRs) and signal-to-noise-ratios, according to some embodiments. The accuracy plots 100 include a PR=20.0% accuracy plot 102, a PR=15.0% accuracy plot 104, a PR=10.0% accuracy plot 106, a PR=5% accuracy plot 108, and a PR=1.0% accuracy plot 110.

An impact of pollution rate may be analyzed with respect to the accuracy plots 100. In a first round of experiments, the following question was posed: assuming a high SR (e.g., ×32, without limitation), what is the impact of noise considering various PR levels? The results indicate that a high PR level (e.g., 20%, corresponding to the PR=20.0% accuracy plot 102), may be detected with high accuracy of above 0.9 even in extremely noisy environments (e.g., SNR −10 dB). Interestingly, the ACC is maintained at near-perfect levels (i.e., 0.963) even at SNR −6 dB. PR of 10% may also be reliably detected with above 0.9 ACC for SNR greater than −4 dB. Finally, the smallest considered PR (i.e., 1%), was detected effectively with above 90% for up to SNR −2 dB. In fact, the ACC was constantly near-perfect 0.988 for up to OdB SNR. Nevertheless, the ACC rapidly degraded for every considered level below −2 dB, by almost a −10% per noise level. FIG. 1 depicts the ACC achieved for various pollution rates and signal-to-noise ratios when the sampling rate is kept constantly high at ×32 (32 times a processor clock rate of a monitored processor).

FIG. 2 illustrates accuracy plots 200 for various levels of sampling rates and signal-to-noise-ratios, according to some embodiments. The accuracy plots 200 include an SR=×32 accuracy plot 202, an SR=×24 accuracy plot 204, an SR=×16 accuracy plot 206, an SR=×8 accuracy plot 208, and an SR=×2 accuracy plot 210 (SRs given in a number of times the processor clock rate).

An impact of sampling rate may be estimated in light of FIG. 2. In light of the previous experiment (FIG. 1), the following question was posed: focusing solely on the detection of injection attacks of the smallest PR (1% PR), what is the impact of noise for various SRs? The case SR of ×32 was analyzed in the previous experiment (with respect to FIG. 1). For lower SR levels of ×16, the anomaly detection yields near-perfect accuracy of 0.958 or higher when SNR levels are up to OdB. In comparison to higher SR levels, one may notice that SR of ×32, ×24, and ×16 (SR=×32 accuracy plot 202, SR=×24 accuracy plot 204, and SR=×16 accuracy plot 206, respectively) yield similar accuracies. When considering SR ×8 (SR=×8 accuracy plot 208) or higher, drastic changes in the accuracy are observed. At SNR −2 dB and −4 dB, the biggest change of approximately 0.150 in the accuracy is seen in comparison to ×16 SR (SR=×16 accuracy plot 206). At the lowest SR tested (SR=×2 accuracy plot 210), injections may not be detected with any certainty. The accuracy at every SNR level was approximately 0.500. FIG. 1 presents the accuracy for various levels of sampling rates and signal-to-noise-ratios (the pollution level is a constant 1%).

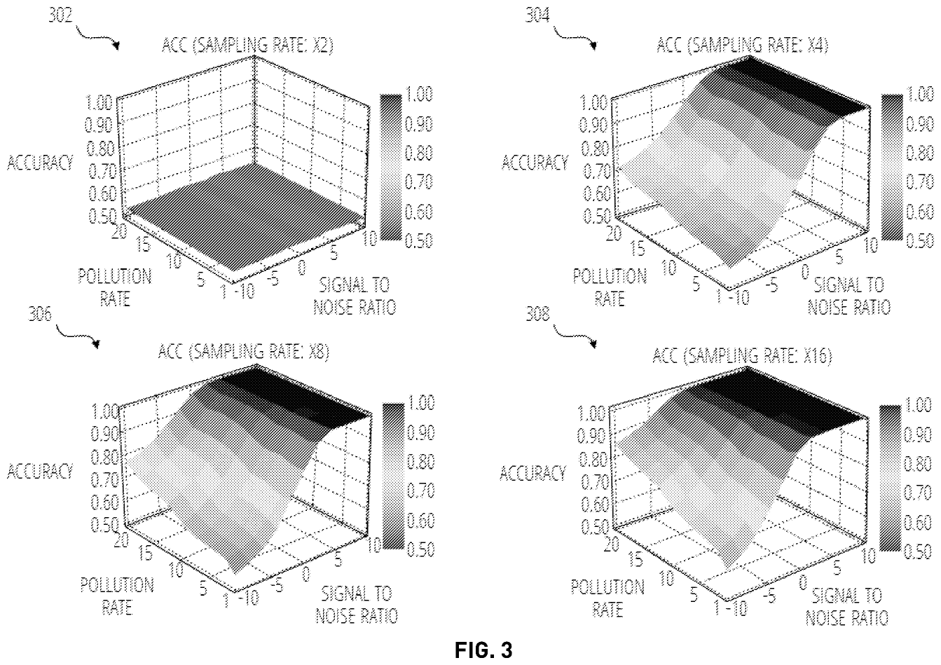

FIG. 3 includes accuracy plots 302, 304, 306, and 308 illustrating accuracy achieved for various pollution rates, SNRs, and sampling rates (SRs), according to some embodiments. FIG. 3 summarizes the ACC achieved across some PR, SR, and SNR levels considered. The accuracy plots 302, 304, 306, and 308 include an SR=×2 accuracy plot 302, an SR=×4 accuracy plot 304, an SR=×8 accuracy plot 306, and an SR=×16 accuracy plot 308.

Based on the information illustrated in the plots of FIG. 1, FIG. 2, and FIG. 3: (a) the higher the PR, the more robust against the influence of noise the anomaly detection becomes, (b) injection attacks at any PR level (1% through 20%) may be detected with near-perfect accuracy when the SNR is no less than 0 dB, (c) very small PR may effectively be detected even in the presence of high environmental noise, (d) SR may be above ×2 to effectively detect any injection code, (e) the higher the SR, the greater the resistance to noise, especially for low SNR levels, and (f) SR faster than ×16 may improve the ACC, but only marginally.

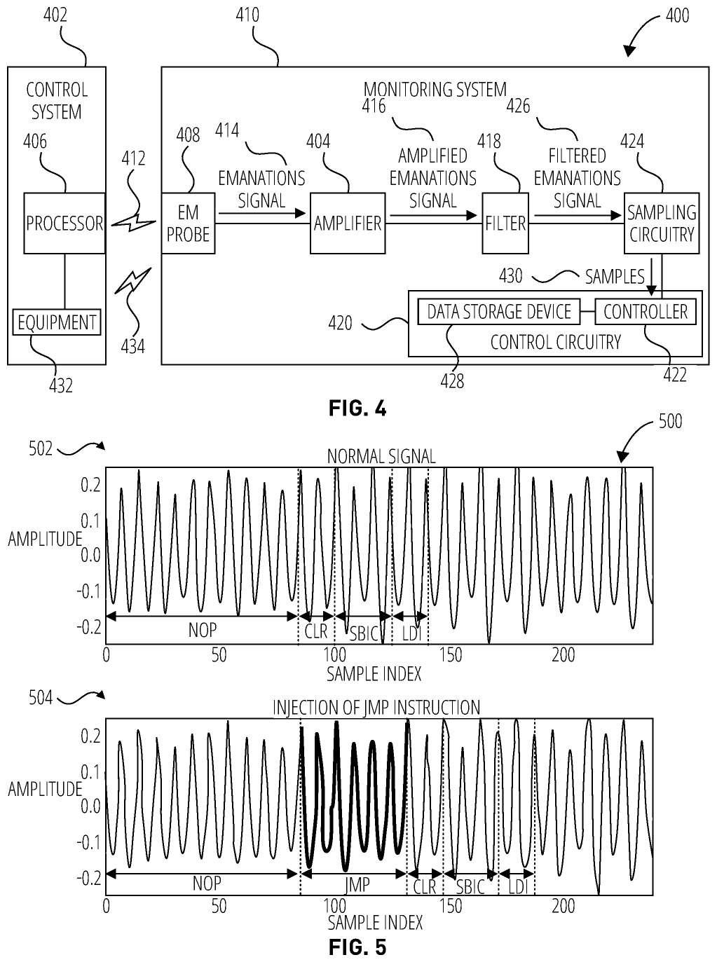

FIG. 4 is a block diagram of a system 400, according to some embodiments. The system 400 includes a control system 402 (e.g., an industrial control system) and a monitoring system 410 to monitor the control system 402. The control system 402 includes a processor 406 and equipment 432. By way of non-limiting example, the processor 406 may include an Arduino Mega. The Arduino Mega is equipped with an 8-bit ATmega2560 AVR microcontroller unit (MCU). This MCU is widely deployed in real-time control applications. The Arduino device family allows developers to run code at the firmware level without the intervention of an operating system (OS) or a runtime environment. For experiments used to generate the data illustrated in the plots of FIG. 1, FIG. 2, and FIG. 3, an Arduino Mega was used as the processor 406, which is a target device for the monitoring system 410.

The processor 406 is configured to control at least a portion of the control system 402 (e.g., at least a portion of the equipment 432). During operation of the control system 402 the processor 406 may generate EM emanations 412 and the equipment 432 may generate EM noise 434.

The monitoring system 410 includes an EM probe 408, an amplifier 404, a filter 418, sampling circuitry 424, and control circuitry 420. By way of non-limiting example, the EM probe 408 may include a near-field probe such as an EMRSS RF Explorer H-Loop, which may be placed on the processor 406 during operation of the control system 402 to receive the EM emanations 412. The EM probe 408 is configured to generate an emanations signal 414 responsive to the EM emanations 412 from the processor 406 and the EM noise 434 from the equipment 432. The emanations signal 414 is indicative of the EM emanations 412 and the EM noise 434. The EM probe 408 is electrically connected to the amplifier 404. The EM probe 408 is configured to provide the emanations signal 414 to the amplifier 404.

The amplifier 404 is configured to receive the emanations signal 414 from the EM probe 408. Since the EM emanations 412 from the processor 406 are transmitted unintentionally, the emanations signal 414 may have a very low amplitude (e.g., too low to enable the sampling circuitry 424 to provide meaningful samples 430). Accordingly, each emanations signal 414 captured may be amplified by the amplifier 404. By way of non-limiting example, the amplifier 404 may include a Beehive 150A EMC probe amplifier. The amplifier 404 is configured to generate an amplified emanations signal 416 responsive to the emanations signal 414 from the EM probe 408. The amplified emanations signal 416 is an amplified version of the emanations signal 414. Accordingly, the amplified emanations signal 416 is indicative of the EM emanations 412 from the processor 406 and the EM noise 434 from the equipment 432. The amplifier 404 is electrically connected to the filter 418. The amplifier 404 is configured to provide the amplified emanations signal 416 to the filter 418.

The filter 418 is configured to receive the amplified emanations signal 416. The filter 418 is configured to filter the amplified emanations signal 416 to generate a filtered emanations signal 426. The filtered emanations signal 426 is a filtered version of the amplified emanations signal 416. In some embodiments the filter 418 includes a singular value decomposition based denoising filter. In some embodiments the filter 418 includes a Wiener filter. In some embodiments the filter 418 includes a k-nearest neighbors (k-NN) regressor. The filter 418 may be selected to reduce a component of the filtered emanations signal 426 corresponding to the EM noise 434 as compared to the amplified emanations signal 416. For example, if a frequency profile of the EM noise 434 is known and the frequency profile of the EM noise 434 does not substantially overlap the EM emanations 412, the filter 418 may be selected to filter out the frequency profile of the EM noise 434. The filter 418 is electrically connected to the sampling circuitry 424. The filter 418 is configured to provide the filtered emanations signal 426 to the sampling circuitry 424.

The sampling circuitry 424 is configured to receive the filtered emanations signal 426 from the filter 418. The sampling circuitry 424 is configured to generate samples 430 of the filtered emanations signal 426 responsive to the filtered emanations signal 426. Less directly, it may be observed that the sampling circuitry 424 is configured to generate the samples 430 responsive to the emanations signal 414, or even responsive to the EM emanations 412. By way of non-limiting example, the sampling circuitry 424 may include an analog to digital converter (ADC). Also by way of non-limiting example, the sampling circuitry 424 may include a PicoScope 3403D oscilloscope, which may save the filtered emanations signal 426 in digital format as the samples 430. The sampling circuitry 424 is electrically connected to the control circuitry 420. The sampling circuitry 424 is configured to provide the samples 430 to the control circuitry 420.

The sampling circuitry 424 is configured to take the samples at a rate that is faster than a processor clock frequency of the processor 406. In some embodiments the sample rate of the sampling circuitry 424 may be configured to sample the filtered emanations signal 426 (and less directly the amplified emanations signal 416) at a rate that is at least eight times greater than the clock frequency of the processor clock of the processor 406. As discussed above, and illustrated in FIG. 1, FIG. 2, and FIG. 3, a sample rate of at least eight times the clock frequency of the processor 406 should enable granular detection of minute anomalies in the EM emanations 412 from the processor 406. By way of non-limiting example, a sampling rate of the sampling circuitry 424 may be set to 250 megasamples per second (MS/sec), which corresponds to a sampling interval of 4 nanoseconds (ns). By way of non-limiting example, a processor clock of the processor 406 may be 16 MHz, which implies that a chosen sampling rate of 250 MS/sec is substantially 15 times higher than the 16 MHz processor clock frequency.

The control circuitry 420 is configured to receive the samples 430 from the sampling circuitry 424. The control circuitry 420 is configured to determine whether or not the processor 406 is exhibiting a behavior anomaly responsive to the samples 430. The control circuitry 420 includes a controller 422 and a data storage device 428. The data storage device 428 is configured to store digitized versions of one or more pre-established normal emanation signals, amplified emanations signals, or filtered emanations signals for the emanations signal 414, the amplified emanations signal 416 and/or the filtered emanations signal 426. The controller 422 of the control circuitry 420 is configured to determine whether the processor 406 is exhibiting the behavior anomaly by determining that a distance score of the emanations signal 414, the amplified emanations signal 416, and/or the filtered emanations signal 426 relative to the one or more pre-stablished normal emanation signals, amplified emanations signals, or filtered emanations signals is within a range defined by one or more pre-determined threshold values.

As a specific, non-limiting example, a control logic coded into the processor 406 may be for a basic tank-filling system. The control logic was implemented in the AVR assembly language. Compared to C, which is the typical choice for developing software in the Arduino platform, the use of assembly allows granular modifications analogous to real adversarial activity.

The chosen adversarial cases include the injection of no operation (NOP), add (ADD), and an unconditional jump (JMP) instructions. In other words, all three malicious cases involve the injection of a single instruction that consumes as little as one (NOP and ADD), and three (JMP) cycles, respectively.

Code injections of such small caliber may not appear meaningful from an adversarial point of view. However, an extraneous NOP may potentially slightly increase the duration of a scan cycle, increasing the frequency of recalibrating the device. Similarly, introducing a malicious ADD instruction may alter the value of an important variable. Finally, the introduction of a JMP may be used for skipping entire blocks of code. These scenarios considered involve the smallest-yet-meaningful modifications ever considered in relevant bibliography.

FIG. 5 illustrates plots of examples of benign and malicious amplified emanations signals 500 (e.g., the amplified emanations signal 416 of FIG. 4), according to some embodiments. The injection of malicious instructions causes an analogous displacement. Examples of a normal filtered emanations signal 502 and a maliciously injected filtered emanations signal 504 (a malicious signal), which are indicative of the EM waves generated by the processor 406 of FIG. 4 during the execution of instructions are given in FIG. 5. For example, the normal filtered emanations signal 502 is an example of the filtered emanations signal 426 without a malicious injection of instructions and the maliciously injected filtered emanations signal 504 is an example of the filtered emanations signal 426 with a malicious JMP instruction injected. Both signals 502, 504 in the experiments are synchronized (the beginning of execution corresponds to the sample with index 0). Synchronization may be achieved by relying on external signals issued at the beginning and the end of the loop. The signals were generated at specific input/output (I/O) pins and were monitored on a separate channel. The impact of the injection of the malicious instructions are highlighted with a bold line in the maliciously injected filtered emanations signal 504. For example, the injection of the NOP causes a displacement of one cycle, the ADD one cycle, and the JMP three cycles.

The predictive accuracy was evaluated using the following metrics: (a) accuracy (ACC), (b) F1 score, and (c) the area under the curve (AUC) score of the corresponding receiver operator characteristic (ROC) curve. While the accuracy has been defined above, the F1 score is defined as the harmonic mean of the precision (PPV) and sensitivity (TPR) as:

$$F 1 = 2 * \frac{PPV * TPR}{PPV + TPR} \qquad ( 7 )$$

where, in turn the precision is defined as:

$$PPV = \frac{TP}{TP + TN} \qquad ( 8 )$$

while the sensitivity is defined as:

$$TPR = \frac{TP}{TP + FN} \qquad ( 9 )$$

A ROC is a popular metric for describing the efficiency of anomaly detection systems. It is essentially a graph illustrating the true-positive rate (TPR) vs. the false positive rate (FPR) for various thresholds. This graph is usually a curve, and since the shape of the curve is arbitrary, the most common method for comparing two ROC curves is by measuring the area under the curve (AUC).

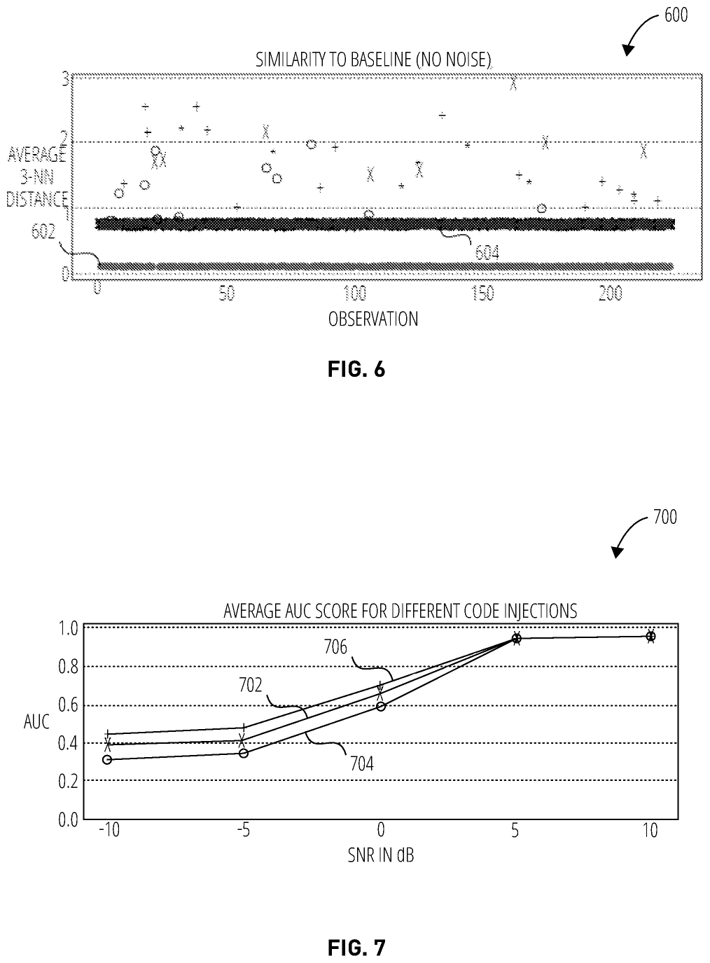

FIG. 6 is an average 3-NN distance plot 600 illustrating an average distance of three closest neighbors (average 3-NN distance) of each individual signal (normal or anomalous) in the dataset to the totality of normal signals that is considered as the baseline, according to some embodiments. In FIG. 6, normal signals are indicated using circles, JMP injected signals are illustrated using “*,” ADD injected signals are illustrated using “X,” and NOP injected signals are illustrated using “+.” Also, a first solid line 602 is formed of circles (normal signals) and a second solid line 604 is formed of “*,” “X,” and “+” (JMP, ADD, and NOP injected signals, respectively).

Single instruction injections may be detected. For example, based at least in part on the previous experiments, it may be possible to detect code injections in noisy environments of very low PR. But the above-discussed experiments may not indicate how low the PR may become before code injections may not be detected. Also, the above-discussed experiments may not indicate whether it is possible to reliably detect single-instruction injection attacks by analyzing the EM signals (e.g., in a clean environment).

In the above-discussed set of experiments, the average AUC score achieved is comparable for all three cases: 0.953 for both the NOP and ADD instructions, while for the JMP instruction, the AUC score was 0.951. The average ACC is 0.975, and the average F1 score is 0.977 for all malicious cases.

FIG. 6 illustrates the average distance of the 3-NN of each signal (normal or anomalous) to the normal signals. The reader may observe that with the exception of a few outliers (estimated below 5%), both normal and anomalous signals consecrate within specific distance ranges that are clearly separable.

The injection of the smallest, meaningful piece of code may be detected effectively with high precision in noise-free environments if the sampling rate is high (e.g., greater than or equal to SR=×8).

FIG. 7 illustrates examples of AUC score plots 700 for average (among all folds) AUC scores achieved across different SNR levels, according to some embodiments. FIG. 7 may be used to evaluate the impact of additive white Gaussian noise (AWGN) to the anomaly detection process. Five variations of the dataset were created by artificially injecting noise of decreasing SNR levels (10 dB, 5 dB, OdB, −5 dB, −10 dB) to the original noise-free datasets. The average AUC scores across the considered SNR levels are illustrated in FIG. 7. The AUC score plots 700 includes an ADD injected AUC score plot 702, a JMP injected AUC score plot 704, and a NOP injected AUC score plot 706. Detailed scores for the considered noise levels are given in Table 1.

TABLE 1
Average AUC, Accuracy, and F1 scores acquired for detecting
three types of injections, under various noise levels.
SNR (dB)

| | | −10 | −5 | 0 | 5 | 10 |
|---|---|---|---|---|---|---|
| AUC | NOP | 0.437 | 0.478 | 0.700 | 0.948 | 0.953 |
| | ADD | 0.389 | 0.409 | 0.654 | 0.945 | 0.952 |
| | JMP | 0.303 | 0.342 | 0.587 | 0.938 | 0.951 |
| ACC | NOP | 0.555 | 0.571 | 0.687 | 0.957 | 0.975 |
| | ADD | 0.535 | 0.540 | 0.661 | 0.946 | 0.975 |
| | JMP | 0.522 | 0.529 | 0.641 | 0.939 | 0.975 |
| F1 | NOP | 0.679 | 0.675 | 0.737 | 0.958 | 0.976 |
| | ADD | 0.671 | 0.676 | 0.717 | 0.948 | 0.976 |
| | JMP | 0.670 | 0.668 | 0.698 | 0.940 | 0.976 |

For these levels, the metrics are maintained close to those achieved in a noise-free environment for SNR levels down to 5 dB. Then, the average AUC score for the considered anomalous cases drops rapidly for SNR levels below 5 dB. More specifically, the average AUC score drops from approximately 0.950 (clean environment) to 0.700 (NOP), 0.654 (ADD), and 0.587 (JMP) at OdB. This indicates a drastic 26% drop for the detection of a NOP, a 31% reduction in the detection of an ADD and a 39% drop in the identification of a JMP. In other words, the drop in AUC score at 0 SNR ranges from approximately 25% to near 40% depending on the type of instruction injected. Then, it further degrades to 0.5 (random coin toss) or below for all SNR levels less than OdB. For example, at SNR −5 dB the AUC score is just 0.478 (NOP), 0.409 (ADD), and 0.342 (JMP). As a result, single-instruction injections are expected to be identified with high precision for SNR levels of approximately 5 dB or above, assuming that the sampling rate is high (e.g., ×15 the CPU clock).

FIG. 8 illustrates example average accuracy plots 800 (among all folds) showing ACC scores achieved after the application of noise elimination filters, for the NOP injection case. Noise filtering was used to quantify the positive impact (if any) of well-known noise filters and noise elimination techniques. Toward this end, representative methods of alternative families of noise reduction/elimination approaches were selected. For example, noise filters based on signal processing, machine learning, and subspace methods were selected. More specifically, (a) Wiener filter, a method that applies linear time-invariant (LTI) filtering to the noisy signals, (b) k-NN regressor, and (c) singular value decomposition (SVD) based denoising were used. Accordingly, the accuracy plots 800 include a no filter accuracy plot 802, a Wiener filter accuracy plot 804, a KNN regressor accuracy plot 806, and an SVD filter accuracy plot 808. Detailed results for each metric and each individual command are given in Table 2.

TABLE 2
Average AUC, Accuracy, and F1 scores acquired for detecting
alternative injections, under various noise levels, after the
application of noise elimination (Wiener, kNN, SVD).
SNR (dB)

| | | | −10 | −5 | 0 | 5 | 10 |
|---|---|---|---|---|---|---|---|
| Wiener | AUC | NOP | 0.612 | 0.786 | 0.982 | 0.945 | 0.976 |
| | | ADD | 0.612 | 0.752 | 0.927 | 0.940 | 0.977 |
| | | JMP | 0.504 | 0.753 | 0.921 | 0.941 | 0.968 |
| | ACC | NOP | 0.680 | 0.774 | 0.948 | 0.957 | 0.975 |
| | | ADD | 0.644 | 0.741 | 0.946 | 0.959 | 0.980 |
| | | JMP | 0.591 | 0.748 | 0.937 | 0.957 | 0.975 |
| | F1 | NOP | 0.724 | 0.794 | 0.953 | 0.960 | 0.977 |
| | | ADD | 0.709 | 0.768 | 0.717 | 0.962 | 0.981 |
| | | JMP | 0.693 | 0.769 | 0.945 | 0.960 | 0.977 |
| | AUC | NOP | 0.534 | 0.576 | 0.842 | 0.952 | 0.953 |
| | | ADD | 0.546 | 0.523 | 0.835 | 0.951 | 0.952 |
| | | JMP | 0.516 | 0.485 | 0.778 | 0.951 | 0.951 |
| kNN | ACC | NOP | 0.618 | 0.618 | 0.819 | 0.975 | 0.975 |
| | | ADD | 0.606 | 0.587 | 0.817 | 0.975 | 0.975 |
| | | JMP | 0.595 | 0.564 | 0.765 | 0.975 | 0.975 |
| | F1 | NOP | 0.693 | 0.687 | 0.829 | 0.976 | 0.976 |
| | | ADD | 0.689 | 0.677 | 0.824 | 0.976 | 0.976 |
| | | JMP | 0.684 | 0.681 | 0.784 | 0.976 | 0.976 |
| | AUC | NOP | 0.975 | 0.963 | 0.953 | 0.952 | 0.953 |
| | | ADD | 0.972 | 0.962 | 0.951 | 0.951 | 0.952 |
| | | JMP | 0.972 | 0.961 | 0.952 | 0.951 | 0.951 |
| SVD | ACC | NOP | 0.982 | 0.979 | 0.975 | 0.975 | 0.975 |
| | | ADD | 0.979 | 0.979 | 0.975 | 0.975 | 0.975 |
| | | JMP | 0.982 | 0.979 | 0.975 | 0.975 | 0.975 |
| | F1 | NOP | 0.982 | 0.980 | 0.976 | 0.976 | 0.976 |
| | | ADD | 0.980 | 0.980 | 0.976 | 0.976 | 0.976 |
| | | JMP | 0.982 | 0.980 | 0.976 | 0.976 | 0.976 |

The filters used to produce the accuracy plots 800 have a positive impact when the SNR levels become significant, e.g., when SNR is 0 dB or below. FIG. 8 illustrates this trend, for the example of the injection of an NOP instruction.

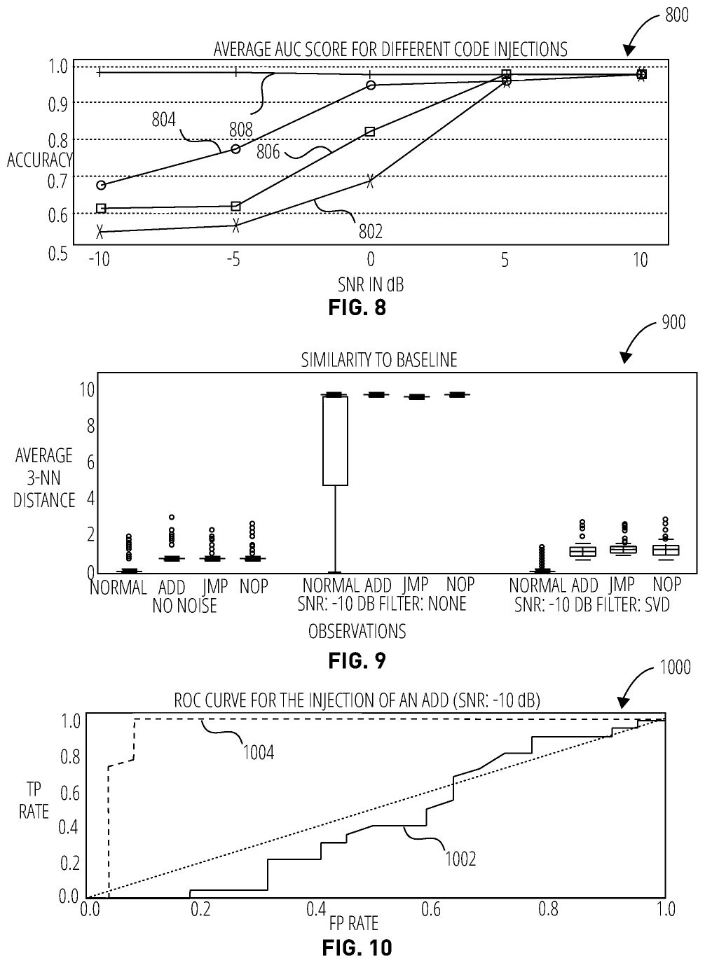

FIG. 9 is a plot 900 illustrating similarity of individual signals to the baseline on the clean dataset (left, “NO NOISE”), a noisy version at −10 dB (middle, “SNR: −10 DB FILTER: NONE”), and a version after applying an SVD noise filter (right, “SNR: −10 DB FILTER: SVD”), according to some embodiments. The SVD denoising is a peculiar case as, unlike other approaches, the SVD method achieved scores comparable to the ones obtained in a clean environment for all metrics, regardless of the SNR levels. This may indicate an advantage of signal subspace methods when applied for purposes of anomaly detection. FIG. 9 illustrates the average similarity of individual signals (normal or anomalous) when compared to the baseline for the clean, noisy (SNR of −10 dB) and denoised versions of the signals. It is noted that the separation between normal and anomalous signals become substantially as clear as in the clean dataset when SVD denoising is applied.

FIG. 10 includes TP rate plots 1000 illustrating improvement on the AUC best fold on noisy environments (−10 dB) and the worst fold after the application of SVD filter, according to some embodiments. To further illustrate the improvement achieved, FIG. 10 presents the best ROC curve among all folds in SNR −10 dB vs. the worst ROC obtained after the application of SVD filters. The TP rate plots 1000 include a no filter (AUC: 0.437) plot 1002 and an SVD (AUC: 0.946) plot 1004. To summarize the results shown in FIG. 10, noise filters augment the anomaly detection process, especially for SNR levels below 0 dB. The SVD method achieves near-perfect accuracy consistently across substantially all SNR levels illustrated in FIG. 10.

The limits of EM-based anomaly detection approaches toward detecting malicious code injection attacks in control logic software have been disclosed herein. While noise may severally degrade the accuracy of the anomaly detection, code injections that alter the execution path minimally to moderately may still be detected even under highly noisy environments if the sampling rate is high enough. Through experiments with real-life equipment, it has been shown that even single-instruction injections may be identified with high accuracy in clean or moderately noisy (e.g., substantially 0 dB SNR) environments. Standard noise elimination techniques may drastically improve the accuracy of the anomaly detection task even in sub 0 dB environments.

With regards to transferability of ML-based anomaly detection models among environments of different levels of noise, existing domain adaptation techniques that may prove beneficial for this application may be improved. Furthermore, principles of SVD denoising may be implemented into ANN autoencoder approaches to achieve optimal (e.g., in a feedback loop fashion) results.

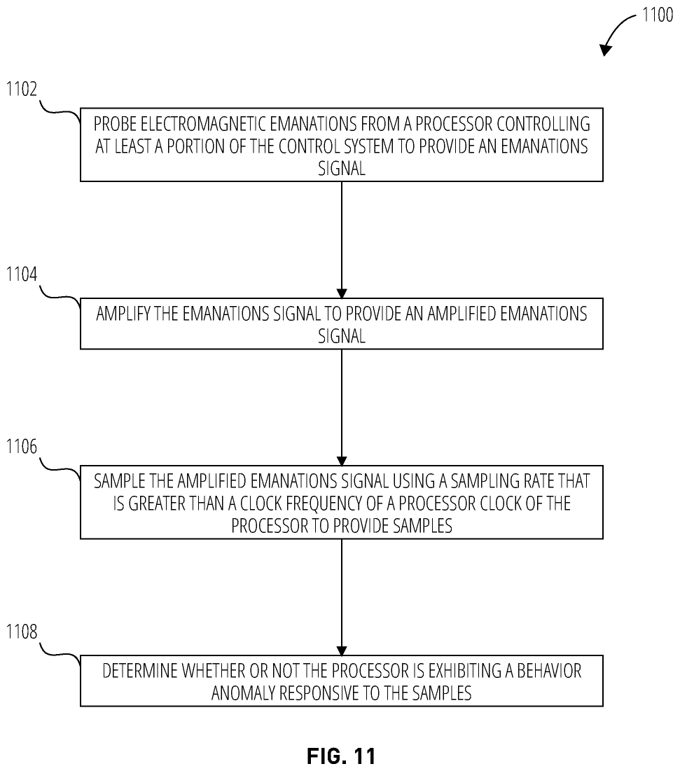

FIG. 11 is a flowchart illustrating a method 1100 of detecting behavior anomalies in a control system (e.g., the control system 402 of FIG. 4), according to some embodiments. At operation 1102 the method 1100 includes probing electromagnetic emanations (e.g., EM emanations 412 of FIG. 4) from a processor (e.g., the processor 406 of FIG. 4) controlling at least a portion of the control system to provide an emanations signal (e.g., the emanations signal 414 of FIG. 4). In some embodiments probing the emanations from the processor controlling at least a portion of the control system includes probing the emanations from the processor controlling at least a portion of an industrial control system (ICS). At operation 1104 the method 1100 includes amplifying the emanations signal to provide an amplified emanations signal (e.g., the amplified emanations signal 416 of FIG. 4).

At operation 1106 the method 1100 includes sampling the amplified emanations signal using a sampling rate that is greater than a clock frequency of a processor clock of the processor to provide samples (e.g., the samples 430 of FIG. 4). In some embodiments sampling the amplified emanations signal includes sampling the amplified emanations signal at a rate between substantially two times the clock frequency and sixteen times the clock frequency. In some embodiments sampling the amplified emanations signal includes at a rate that is greater than or equal to substantially sixteen times the clock frequency. In some embodiments sampling the amplified emanations signal includes filtering the amplified emanations signal to provide a filtered emanations signal (e.g., the filtered emanations signal 426 of FIG. 4) and sampling the filtered emanations signal to provide the samples. In some embodiments filtering the amplified emanations signal includes filtering the amplified emanations signal using a singular value decomposition based denoising. In some embodiments filtering the amplified emanations signal includes filtering the amplified emanations signal using a Wiener filter. In some embodiments filtering the amplified emanations signal includes filtering the amplified emanations signal using a k-nearest neighbors (k-NN) regressor.

At operation 1108 the method 1100 includes determining whether or not the processor is exhibiting a behavior anomaly responsive to the samples. In some embodiments determining whether or not the processor is exhibiting a behavior anomaly responsive to the samples includes determining that a distance score of the amplified emanations signal relative to one or more pre-established normal emanation signals is within a range defined by one or more pre-determined threshold values.

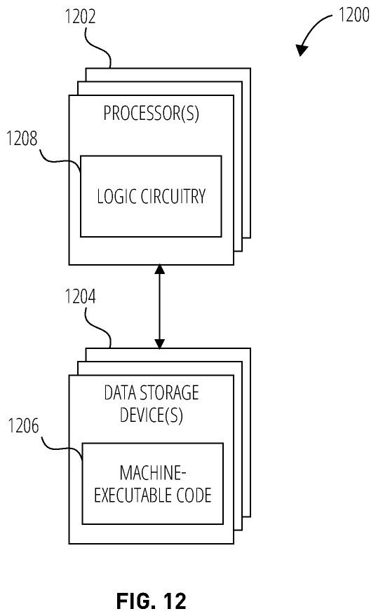

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 12 illustrates non-limiting examples of implementations of functional elements disclosed herein. In some embodiments, some or all portions of the functional elements disclosed herein may be performed by hardware specially configured for carrying out the functional elements.

FIG. 12 is a block diagram of circuitry 1200 that, in some embodiments, may be used to implement various functions, operations, acts, processes, and/or methods disclosed herein. The circuitry 1200 includes one or more processors 1202 (sometimes referred to herein as “processors 1202”) operably coupled to one or more data storage devices (sometimes referred to herein as “storage 1204”). The storage 1204 includes machine-executable code 1206 stored thereon and the processors 1202 include logic circuitry 1208. The machine-executable code 1206 includes information describing functional elements that may be implemented by (e.g., performed by) the logic circuitry 1208. The logic circuitry 1208 is adapted to implement (e.g., perform) the functional elements described by the machine-executable code 1206. The circuitry 1200, when executing the functional elements described by the machine-executable code 1206, should be considered as special purpose hardware configured for carrying out functional elements disclosed herein. In some embodiments the processors 1202 may be configured to perform the functional elements described by the machine-executable code 1206 sequentially, concurrently (e.g., on one or more different hardware platforms), or in one or more parallel process streams.

When implemented by logic circuitry 1208 of the processors 1202, the machine-executable code 1206 is configured to adapt the processors 1202 to perform operations of embodiments disclosed herein. By way of non-limiting examples, the machine-executable code 1206 may be configured to adapt the processors 1202 to perform at least a portion of the method 1100 of FIG. 11 (e.g., operation 1108). Also by way of non-limiting examples, the machine-executable code 1206 may be configured to adapt the processors 1202 to perform at least a portion of the operations discussed above for the controller 422 and/or the control circuitry 420 of FIG. 4.

The processors 1202 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1206 (e.g., software code, firmware code, hardware descriptions) related to embodiments of the present disclosure. It is noted that a general-purpose processor (may also be referred to herein as a host processor or simply a host) may be a microprocessor, but in the alternative, the processors 1202 may include any conventional processor, controller, microcontroller, or state machine. The processors 1202 may also be implemented as a combination of computing devices, such as a combination of a DSP and a microprocessor, a plurality of microprocessors, one or more microprocessors in conjunction with a DSP core, or any other such configuration.

In some embodiments the storage 1204 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 1202 and the storage 1204 may be implemented into a single device (e.g., a semiconductor device product, a system on chip (SOC), etc.). In some embodiments the processors 1202 and the storage 1204 may be implemented into separate devices.

In some embodiments the machine-executable code 1206 may include computer-readable instructions (e.g., software code, firmware code). By way of non-limiting example, the computer-readable instructions may be stored by the storage 1204, accessed directly by the processors 1202, and executed by the processors 1202 using at least the logic circuitry 1208. Also by way of non-limiting example, the computer-readable instructions may be stored on the storage 1204, transferred to a memory device (not shown) for execution, and executed by the processors 1202 using at least the logic circuitry 1208. Accordingly, in some embodiments the logic circuitry 1208 includes electrically configurable logic circuitry 1208.

In some embodiments the machine-executable code 1206 may describe hardware (e.g., circuitry) to be implemented in the logic circuitry 1208 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1208 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine-executable code 1206 may include an HDL, an RTL, a GL description, a mask level description, other hardware description, or any combination thereof.

In embodiments where the machine-executable code 1206 includes a hardware description (at any level of abstraction), a system (not shown, but including the storage 1204) may be configured to implement the hardware description described by the machine-executable code 1206. By way of non-limiting example, the processors 1202 may include a programmable logic device (e.g., an FPGA or a PLC) and the logic circuitry 1208 may be electrically controlled to implement circuitry corresponding to the hardware description into the logic circuitry 1208. Also by way of non-limiting example, the logic circuitry 1208 may include hard-wired logic manufactured by a manufacturing system (not shown, but including the storage 1204) according to the hardware description of the machine-executable code 1206.

Regardless of whether the machine-executable code 1206 includes computer-readable instructions or a hardware description, the logic circuitry 1208 is adapted to perform the functional elements described by the machine-executable code 1206 when implementing the functional elements of the machine-executable code 1206. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present disclosure is not so limited. Rather, many additions, deletions, and modifications to the illustrated and described embodiments may be made without departing from the scope of the disclosure as hereinafter claimed along with their legal equivalents. In addition, features from one embodiment may be combined with features of another embodiment while still being encompassed within the scope of the disclosure.

1. A monitoring system to monitor a control system, the monitoring system comprising:
an electromagnetic (EM) probe configured to generate an emanations signal responsive to EM emanations from a processor configured to control at least a portion of the control system;
an amplifier configured to generate an amplified emanations signal responsive to the emanations signal; and
control circuitry configured to determine whether the processor is exhibiting a behavior anomaly responsive to samples taken of the amplified emanations signal, the samples taken at a rate that is faster than a processor clock frequency of the processor.

2. The monitoring system of claim 1, wherein the control circuitry includes sampling circuitry configured to generate the samples of the amplified emanations signal.

3. The monitoring system of claim 2, wherein the sampling circuitry is configured to sample the amplified emanations signal at a rate that is at least eight times greater than a clock frequency of a processor clock of the processor.

4. The monitoring system of claim 1, wherein the control circuitry includes a controller configured to determine whether the processor is exhibiting the behavior anomaly by determining that a distance score of the amplified emanations signal relative to one or more pre-established normal emanation signals is within a range defined by one or more pre-determined threshold values.

5. The monitoring system of claim 1, wherein the control circuitry includes a filter configured to filter the amplified emanations signal.

6. The monitoring system of claim 5, wherein the filter comprises a singular value decomposition based denoising filter.

7. The monitoring system of claim 5, wherein the filter comprises a Wiener filter.

8. The monitoring system of claim 5, wherein the filter comprises a k-nearest neighbors (k-NN) regressor.

9. A method of detecting behavior anomalies in a control system, the method comprising:
probing electromagnetic (EM) emanations from a processor controlling at least a portion of the control system to provide an emanations signal;
amplifying the emanations signal to provide an amplified emanations signal;
sampling the amplified emanations signal using a sampling rate that is greater than a clock frequency of a processor clock of the processor to provide samples; and
determining whether or not the processor is exhibiting a behavior anomaly responsive to the samples.

10. The method of claim 9, wherein determining whether or not the processor is exhibiting the behavior anomaly responsive to the samples comprises determining that a distance score of the amplified emanations signal relative to one or more pre-established normal emanation signals is within a range defined by one or more pre-determined threshold values.

11. The method of claim 9, wherein sampling the amplified emanations signal comprises sampling the amplified emanations signal at a rate between substantially two times the clock frequency and sixteen times the clock frequency.

12. The method of claim 9, wherein sampling the amplified emanations signal comprises sampling the amplified emanations signal at a rate that is greater than or equal to substantially sixteen times the clock frequency.

13. The method of claim 9, wherein sampling the amplified emanations signal comprises:
filtering the amplified emanations signal to provide a filtered emanations signal; and
sampling the filtered emanations signal to provide the samples.

14. The method of claim 13, wherein filtering the amplified emanations signal comprises filtering the amplified emanations signal using a singular value decomposition based denoising.

15. The method of claim 13, wherein filtering the amplified emanations signal comprises filtering the amplified emanations signal using a Wiener filter.

16. The method of claim 13, wherein filtering the amplified emanations signal comprises filtering the amplified emanations signal using a k-nearest neighbors (k-NN) regressor.

17. The method of claim 9, wherein probing the EM emanations from the processor controlling at least a portion of the control system comprises probing the EM emanations from the processor controlling at least a portion of an industrial control system (ICS).

18. A system, comprising:
an industrial control system including a processor configured to control at least a portion of the industrial control system; and
a monitoring system comprising:
an electromagnetic (EM) probe configured to generate an emanations signal responsive to EM emanations from the processor;
sampling circuitry configured to generate samples responsive to the emanations signal; and
control circuitry configured to determine whether the processor is exhibiting a behavior anomaly responsive to the samples.

19. The system of claim 18, wherein the control circuitry further comprises a data storage device configured to store one or more pre-established normal emanation signals.

20. The system of claim 19, wherein the control circuitry is further configured to determine whether the processor is exhibiting the behavior anomaly by determining that a distance score of the emanations signal relative to the one or more pre-established normal emanation signals is within a range defined by one or more pre-determined threshold values.
